(19) United States
(12) Patent Application Publication
(10) Pub. No.: US 2026/0155397 A1
(43) Pub. Date: Jun. 4, 2026

(54) ELECTRODE, RECHARGEABLE LITHIUM BATTERY INCLUDING THE SAME AND MANUFACTURING METHOD FOR RECHARGEABLE LITHIUM BATTERY

(71) Applicant: SAMSUNG SDI CO., LTD., Yongin-si (KR)

(72) Inventor: Hyunwoo KIM, Yongin-si (KR)

(73) Assignee: SAMSUNG SDI CO., LTD., Yongin-si (KR)

(21) Appl. No.: 19/287,466

(22) Filed: Jul. 31, 2025

(30) Foreign Application Priority Data
Dec. 4, 2024 (KR) 10-2024-0178194

(51) Int. Cl. H01M 4/75; H01M 4/04; H01M 4/13; H01M 4/139; H01M 4/66; H01M 10/0525; H01M 10/058

(52) U.S. Cl. CPC H01M 4/75; H01M 4/0404; H01M 4/13; H01M 4/139; H01M 4/661; H01M 10/0525; H01M 10/058

(57) ABSTRACT

The present disclosure relates to a rechargeable lithium battery. More particularly, the rechargeable lithium battery includes an electrode substrate, an electrode active material block coated on the electrode substrate, and a membrane stacked on the electrode active material block. The electrode substrate includes at least one wire embedded in the electrode active material block. A three-dimensional structure is formed in a partial region of the electrode substrate, and the electrode active material block is configured to surround the three-dimensional structure.

### CROSS-REFERENCE TO RELATED APPLICATION

The present application claims priority to Korean Patent Application No. 10-2024-0178194, filed on Dec. 4, 2024, the entire content of which is hereby incorporated by reference.

### BACKGROUND

The present disclosure relates to an electrode for a rechargeable lithium battery, a rechargeable lithium battery, and a method for manufacturing a rechargeable lithium battery. For example, the present disclosure relates to the electrode for the rechargeable lithium battery, the rechargeable lithium battery, and the method for manufacturing the rechargeable lithium battery, in which the binding strength between the electrode substrate and the electrode active material may be increased by applying a wire-shaped electrode substrate, and may improve process efficiency.

With the proliferation of battery-powered electronic devices such as, e.g., mobile phones, notebook computers, electric vehicles, and the like, the demand for rechargeable batteries with high energy density and large capacity has been increasing significantly. In response, extensive research and development efforts have been made to enhance the performance of rechargeable lithium batteries.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

With increasing industrial demand, the development of high-energy-density and highly safe batteries has been actively pursued. Lithium-ion batteries, for instance, have been widely commercialized not only for consumer electronics and communication devices, but also in the automotive industry. In automotive applications, battery safety is of paramount importance due to the direct impact thereof on preserving human lives.

For example, all-solid-state batteries, which use a solid electrolyte instead of a liquid electrolyte, have been proposed as a promising alternative. Unlike conventional lithium-ion batteries that contain flammable organic solvents, all-solid-state batteries significantly reduce the risk of fire or explosion, even in the event of a short circuit. As a result, all-solid-state batteries offer a substantial improvement in safety compared to lithium-ion batteries utilizing liquid electrolytes.

### SUMMARY

The present disclosure describes an electrode for a rechargeable lithium battery that may increase the binding strength between an electrode substrate and an electrode active material by applying a wire-shaped electrode substrate.

The present disclosure describes a rechargeable lithium battery in which the binding strength between an electrode substrate and an electrode active material is enhanced by applying a wire-shaped electrode substrate.

The present disclosure describes a method for manufacturing a rechargeable lithium battery by applying a wire-shaped electrode substrate to enhance the binding strength between the electrode substrate and the electrode active material, and to improve process efficiency.

An example embodiment of the present disclosure may include an electrode for a rechargeable lithium battery, including an electrode substrate, and an electrode active material block coated on the electrode substrate.

The electrode substrate may include at least one wire embedded in the electrode active material block. A three-dimensional structure may be formed in a partial region of the electrode substrate, and the electrode active material block may surround the three-dimensional structure.

An example embodiment of the present disclosure may include a rechargeable lithium battery, including an electrode substrate, an electrode active material block coated on the electrode substrate, and a membrane stacked on the electrode active material block.

The electrode substrate may include at least one wire embedded in the electrode active material block. A three-dimensional structure may be formed in a partial region of the electrode substrate, and the electrode active material block may surround the three-dimensional structure.

An example embodiment of the present disclosure may include a method for manufacturing a rechargeable lithium battery, including forming an electrode substrate, and coating an electrode active material block on the electrode substrate.

The electrode substrate may include at least one wire, and the wire may be embedded in the electrode active material block. Forming the electrode substrate may include forming a three-dimensional structure in a partial region of the electrode substrate.

### BRIEF DESCRIPTION OF DRAWINGS

FIG. 1 is a cross-sectional view illustrating a unit cell of an all-solid-state battery, according to example embodiments of the present disclosure.

FIG. 2 illustrates a wire-shaped electrode substrate and an electrode active material block, according to example embodiments of the present disclosure.

FIG. 3A illustrates a wire-shaped electrode substrate according to an example embodiment of the present disclosure.

FIG. 3B illustrates a state in which an electrode active material block is coated on the electrode substrate shown in FIG. 3A.

FIG. 4A illustrates a wire-shaped electrode substrate according to an example embodiment of the present disclosure.

FIG. 4B illustrates a state in which an electrode active material block is coated on the electrode substrate shown in FIG. 4A.

FIG. 5A illustrates a wire-shaped electrode substrate according to an example embodiment of the present disclosure.

FIG. 5B illustrates a state in which an electrode active material block is coated on the electrode substrate shown in FIG. 5A.

FIGS. 6A and 6B illustrate a wire-shaped electrode substrate according to an example embodiment of the present disclosure.

FIGS. 7A and 7B illustrate a wire-shaped electrode substrate according to an example embodiment of the present disclosure.

FIG. 8A illustrates a state in which a plurality of electrode active material blocks are coated on a wire-shaped electrode according to example embodiments of the present disclosure.

FIG. 8B illustrates a state in which a second wire part of the electrode substrate disclosed in FIG. 8A is folded to stack a plurality of electrode active material blocks in multiple layers.

FIG. 9 illustrates a bi-cell form of a rechargeable lithium battery according to example embodiments of the present disclosure.

FIG. 10 illustrates a state in which the second wire part of the electrode substrate in FIG. 9 is cut in to form the second wire part as an electrode tab.

FIG. 11 is a diagram illustrating a rechargeable lithium battery manufacturing method according to example embodiments of the present disclosure.

### DETAILED DESCRIPTION OF EMBODIMENTS

To fully understand the configuration and effects of the present disclosure, some example embodiments are described with reference to the accompanying drawings. However, the present disclosure is not limited to the following example embodiments, and may be implemented in various forms. The example embodiments are included solely to illustrate the present disclosure and to enable those skilled in the art to fully understand the scope thereof.

In this description, when an element is described as being “on” another element, the element may be “directly on” the other element, or one or more intervening elements may be present therebetween. In the drawings, certain thicknesses may be exaggerated to better illustrate technical details. Throughout the specification, like reference numerals indicate like elements.

The example embodiments described herein may be illustrated using sectional and/or plan views, which may be presented as idealized examples of the present disclosure. The thicknesses of layers and regions in the drawings may be exaggerated for clarity. The regions shown in the drawings are for illustrative purposes and should not be construed as limiting the scope of the present disclosure. Although terms such as “first,” “second,” and “third” may be used to describe various elements, these terms are merely for distinction and do not imply any particular order or hierarchy. The example embodiments described and illustrated herein include complementary variations.

The terms used in this description serve only to explain various embodiments and are not intended to limit the present disclosure. Unless explicitly stated otherwise, singular forms may also include plural forms. The terms “comprises/includes” and “comprising/including” do not exclude the presence or addition of one or more other components. When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

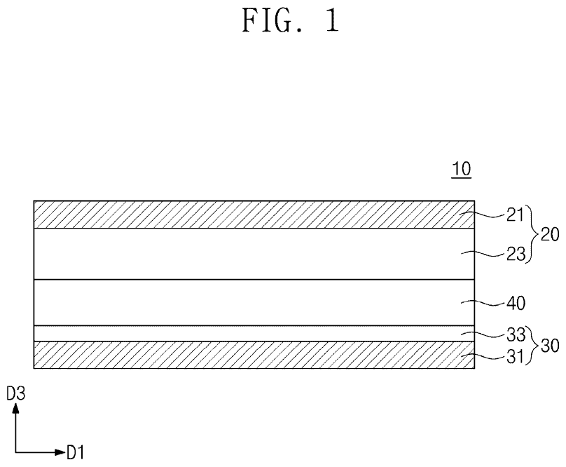

FIG. 1 discloses a unit cell form of an all-solid-state battery cell 10, according to example embodiments of the present disclosure.

Referring to FIG. 1, an all-solid-state battery cell 10 may include a positive electrode layer 20, a negative electrode layer 30 opposite to the positive electrode layer 20, and a solid electrolyte layer 40 disposed between the positive electrode layer 20 and the negative electrode layer 30. However, without being limited thereto, the all-solid-state battery cell 10 may further include an additional functional layer, for example, an adhesion-improving layer, disposed between the positive electrode layer 20 and the solid electrolyte layer 40, or between the negative electrode layer 30 and the solid electrolyte layers 40.

The positive electrode layer 20 may include a positive electrode current collector 21 and a positive electrode active material layer 23 disposed on the positive electrode current collector 21. The positive electrode active material layer 23 may include at least one of a positive electrode active material, a solid electrolyte, a conductive material, and a binder.

The positive electrode current collector 21 may provide a reference surface on which the positive electrode active material layer 23 is disposed. The positive electrode current collector 21 may have a plate or foil shape. For example, the positive electrode current collector 21 may include at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy or combination thereof.

Unlike the illustration in FIG. 1, in an example embodiment of the present disclosure, the positive electrode current collector 21 can be omitted. Although not illustrated, a carbon layer having a thickness in a range of about 0.1 μm to about 4 μm may be further disposed between the positive electrode current collector 21 and the positive electrode active material layer 23 in order to increase the binding force between the positive electrode collector 21 and the negative electrode active material layer 22.

The positive electrode active material may include a material capable of reversibly absorbing and desorbing lithium ions. For example, the positive electrode active material may include, but is not limited to, lithium transition metal oxides such as at least one of lithium cobalt oxide (LCO), lithium nickel oxide, lithium nickel cobalt oxide, lithium nickel-cobalt-aluminum oxide (NCA), lithium nickel-cobalt-manganese oxide (NCM), lithium manganate, and lithium iron phosphate, nickel sulfide, copper sulfide, lithium sulfide, iron oxide, or vanadium oxide. The positive electrode active material may be a single material, or may be a mixture of two or more materials.

The lithium transition metal oxide may be or include, for example, a compound represented by one of LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄. In the compounds above, “A” may be or include at least one of Ni, Co, Mn, or a combination thereof, “B” may be or include at least one of Al, Ni, Co, Mn, Cr, Fe, Mg, Sr, V, a rare-earth element, or a combination thereof, “D” may be or include at least one of O, F, S, P, or a combination thereof, “E” may be or include at least one of Co, Mn, or a combination thereof, “F” may be or include at least one of F, S, P, or a combination thereof, “G” may be or include at least one of Al, Cr, Mn, Fe, Mg, La, Ce, Sr, V, or a combination thereof, “Q” may be or include at least one of Ti, Mo, Mn, or a combination thereof, “I” may be or include at least one of Cr, V, Fe, Sc, Y, or a combination thereof, and “J” may be or include at least one of V, Cr, Mn, Co, Ni, Cu, or a combination thereof.

The positive electrode active material may include, for example, a lithium salt of a transition metal oxide having a layered rock salt type structure among lithium transition metal oxides discussed above. The term “layered rock salt type structure” may refer to a structure in which an oxygen atom layer and a metal atom layer are alternately and regularly arranged in a <111> direction of a cubic rock salt type structure, where each atom layer forms a two-dimensional plane. The term “cubic rock salt type structure” may refer to a sodium chloride (NaCl) type structure, which is a type of crystal structure, and for example, has a structure in which face centered cubic lattices (FCCs) each formed of cations and anions are arranged displaced from each other by ½ (half) of a ridge of a unit lattice. The lithium transition metal oxide having the layered rock salt type structure may be or include a ternary lithium transition metal oxide, such as LiNixCoyAlzO2 (NCA) or LiNixCoyMnzO2 (NCM) (where 0<x<1,0<y<1, 0<z<1, and x+y+z=1). When the positive electrode active material includes a ternary lithium transition metal oxide having the layered rock salt type structure, the unit cell may have increased energy density and improved thermal stability.

The compound included in the positive electrode active material may be covered with a coating layer (not shown). The positive electrode active material may be used in a mixture of the compound and a compound to which the coating layer is added. The coating layer added to a surface of the positive electrode active material may include, for example, at least one of oxide, hydroxide, oxyhydroxide, oxycarbonate, or hydrocarbonate of a coating element discussed below. The compound that constitutes the coating layer may be amorphous or crystalline. The coating element included in the coating layer may include at least one of Mg, Al, Co, K, Na, Ca, Si, Ti, V, Sn, Ge, Ga, B, As, Zr, or a mixture thereof. The coating layer may include, for example, Li₂O—ZrO₂ (LZO). A method for forming the coating layer may be chosen from any methods that do not adversely affect physical characteristics of the positive electrode active material. The method of forming the coating layer may include, for example, spray coating or immersion.

When the positive electrode active material includes nickel (Ni) as a ternary lithium transition metal oxide such as NCA or NCM, for example, it is possible to increase the capacity density of the unit cell and reduce metal elution of the positive electrode active material in a charged state. As a result, cycle characteristics in a charged state of the unit cell may be improved. The “cycle characteristic” may refer to properties that indicate the degree to which the unit cell is degraded due to charge and discharge. For example, the unit cell with high cycle characteristics may degrade less due to charge and discharge, while the unit cell with low cycle characteristics may degrade more due to charge and discharge.

The positive electrode active material may have, for example, a spherical or oval particle shape. The particle diameter and content of the positive electrode active material are not limited.

The solid electrolyte may include a sulfide-based solid electrolyte having desired or improved lithium-ion conductivity characteristics. The sulfide-based solid electrolyte may include, for example, at least one of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li2S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is or includes one of Ge, Zn, and Ga), Li₂S—GeS₂, Li₂S—SiS₂—Li₃PO₄, Li₂S—SiS₂—LiₚMO_{q} (where p and q are each a positive integer, and “M” is or includes one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be or include, for example, an Argyrodite-type compound including at least one of Li₇₋ₓPS₆₋ₓClₓ (0≤x≤2), Li₇₋ₓSP₆₋ₓBrₓ (0≤x≤2), or Li₇₋ₓPS₆₋ₓIₓ (0≤x≤2). For example, the sulfide-based solid electrolyte may include an argyrodite-type compound including at least one of Li₆PS₅Cl, Li₆PS₅Br or Li₆PS₅I.

The density of the argyrodite-type solid electrolyte SEP may be in a range of about 1.5 g/cc to about 2.0 g/cc. Since the argyrodite-type solid electrolyte SEP has a density of about 1.5 g/cc or more, the internal resistance of the all-solid-state battery may be reduced, and it may be possible to reduce or prevent the solid electrolyte membrane from penetrating and short-circuiting due to the formation of lithium dendrites. The elastic modulus of the solid electrolyte SEP may be, for example, in a range of about 15 GPa to about 35 GPa.

The solid electrolyte in the positive electrode active material layer 23 may have a smaller average particle diameter than the solid electrolyte in the solid electrolyte layer 40 to be described below. For example, the average particle diameter of the solid electrolyte SEP of the positive electrode active material layer CML may be in a range of about 90% or less, about 80% or less, about 70% or less, about 60% or less, about 50% or less, about 40% or less, about 30% or less, or about 20% or less of an average particle diameter of a solid electrolyte of the solid electrolyte layer. The average particle diameter may be a median diameter measured using, e.g., a laser particle size distribution analyzer.

The positive electrode active material layer 23 may further include a conductive material. The conductive material may have conductivity without causing an adverse chemical change in the unit cell, thereby increasing the conductivity of the positive electrode active material and the solid electrolyte. The conductive material may include a carbon-based material. The conductive material may include, for example, at least one of graphite, carbon black, acetylene black, carbon nanofibers, or carbon nanotubes.

The positive electrode active material layer 23 may further include a binder. The binder may combine the positive electrode active material, the solid electrolyte, and the conductive material within the positive electrode active material layer 23 together. The binder may include a material that is configured to improve adhesion between the positive electrode active material layer 23 and the positive electrode current collector 21. The binder may include, for example, at least one of polyvinylidene fluoride, styrene butadiene rubber (SBR), polytetrafluoroethylene, vinylidene fluoride/hexafluoropropylene copolymer, polyacrylonitrile, or polymethylmethacrylate.

When the total amount of the positive electrode active material, the solid electrolyte, the conductive material, and the binder is 100 parts by weight, the positive electrode active material layer 23 may include about 85 parts by weight to about 92 parts by weight of the positive electrode active material. The positive electrode active material layer 23 may include about 0.5 parts by weight to about 1.5 parts by weight of a binder.

In the positive electrode active material layer 23, the conductive material may have about 1 part by weight to about 50 parts by weight with respect to 100 parts by weight of the solid electrolyte. When the amount of the conductive material is less than about 1 part by weight with respect to 100 parts by weight of the solid electrolyte, the electrical conductivity of the positive electrode active material layer 23 may be lowered. When the amount of the conductive material is more than about 50 parts by weight with respect to 100 parts by weight of the solid electrolyte, the proportion of the conductive material may be excessively or substantially high and the coating layer covering the surface of the solid electrolyte may not be properly formed.

According to example embodiments of present disclosure, the positive electrode active material layer 23 may further include at least one additive such as or including at least one of a filler, a coating agent, a dispersant, and an ion conductive auxiliary agent in addition to the positive electrode active materials, the solid electrolyte, the conductive material, and the binder described above.

The solid electrolyte layer 40 may be provided between the positive electrode layer 20 and the negative electrode layer 30. The solid electrolyte layer 40 may include a sulfide-based solid electrolyte having desired or improved lithium-ion conductivity. The solid electrolyte in the solid electrolyte layer 40 may be the same as or different from any one of the materials included in the solid electrolyte in the positive electrode active material layer 23 described above.

In an example embodiment, the solid electrolyte layer 40 may include a sulfide-based solid electrolyte. The sulfide-based solid electrolyte may be produced, for example, by treating starting materials such as Li₂S and P₂S₅ by a melt quenching method, a mechanical milling method, or the like. In addition, after such treatment, heat treatment may be performed.

The solid electrolyte may be amorphous, crystalline, or a mixture thereof. Additionally, the solid electrolyte may include, for example, at least one of sulfur(S), phosphorus (P), and lithium (Li) as at least constituent elements among the above-described sulfide-based solid electrolyte material. For example, the solid electrolyte may be a material including Li₂S—P₂S₅. When a sulfide-based solid electrolyte material forming the solid electrolyte includes Li₂S—P₂S₅, the molar mixing ratio of Li₂S to P₂S₅ may range from about 50:50 to about 90:10.

In an example embodiment, the solid electrolyte may include an argyrodite-type compound including at least one of Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). The solid electrolyte may include an argyrodite-type compound including at least one of Li₆PS₅Cl, Li₆PS₅Br or Li₆PS₅I.

The density of argyrodite-type solid electrolyte may be in a range of about 1.5 g/cc to about 2.0 g/cc. Since the argyrodite-type solid electrolyte has a density of about 1.5 g/cc or more, the internal resistance of the all-solid-state battery may be reduced, and it may be possible to hinder or prevent the solid electrolyte membrane from penetrating and short-circuiting due to the formation of lithium dendrites. The elastic modulus of the solid electrolyte may be, for example, in a range of about 15 GPa to about 35 GPa.

The solid electrolyte layer 40 may further include a binder. The binder included in the solid electrolyte layer 40 may be or include, for example, at least one of styrene-butadiene rubber (SBR), polytetrafluoroethylene, polyvinylidene fluoride, polyethylene or the like, but is not limited thereto. For example, the binder included in the solid electrolyte layer 40 may include at least one of styrene-butadiene rubber (SBR), polytetrafluoroethylene, polyvinylidene fluoride, polyethylene, and polyacrylate. The binder of the solid electrolyte layer 40 may be the same as or different from the binder included in the positive electrode active material layer 23 or the binder included the negative electrode coating layer 33.

The negative electrode layer 30 may include a negative electrode current collector 31 and a negative electrode coating layer 33 on the negative electrode current collector 31. The negative electrode current collector 31 may provide a reference surface on which the negative electrode coating layer 33 is disposed.

The negative electrode current collector 31 may include, for example, a material that does not react with lithium, that is, does not form both an alloy and a compound with lithium. For example, the negative electrode current collector 31 may include at least one metal such as or including at least one of copper (Cu), stainless steel, titanium (Ti), iron (Fe), cobalt (Co), and nickel (Ni). The thickness of the negative electrode current collector 31 may be in a range of about 1 μm to about 20 μm, for example, 5 about μm to about 15 μm, and for example, about 7 μm to about 10 μm.

The negative electrode current collector 31 may be composed of or include a single metal such as or including at least one of the above-described metals or may include an alloy or a coated material including two or more metals. The negative electrode current collector 31 may be in the form of, for example, a plate or a foil. In some example embodiments, the negative electrode current collector 31 may be omitted.

The negative electrode coating layer 33 may be configured such that lithium metal is grown between the negative electrode current collector 31 and the negative electrode coating layer 33 during charging of the all-solid-state battery cell 10. The negative electrode coating layer 33 may constitute a protective layer of lithium metal and reduce or suppress deposition and growth of lithium dendrite.

The negative electrode coating layer 33 may include a metal and carbon. For example, the negative electrode coating layer 33 may include at least one metal such as or including at least one of gold (Au), platinum (Pt), palladium (Pd), silicon (Si), silver (Ag), aluminum (Al), bismuth (Bi), tin (Sn), and zinc (Zn). The metal of the negative electrode coating layer 33 may help lithium ions move toward the negative electrode current collector 31 during charging and discharging of the all-solid-state battery.

The negative electrode coating layer 33 may include at least one of amorphous carbon, crystalline carbon, or porous carbon. The negative electrode coating layer 33 may include at least one carbon such as or including at least one of carbon black, acetylene black, furnace black, ketjen black, and graphene. The carbon in the negative electrode coating layer 33 may reduce or minimize the volume change of the all-solid-state battery during charging and discharging, and may provide structural stability of the negative electrode coating layer 33.

In an example embodiment, the negative electrode coating layer 33 may include a mixture (or composite) of carbon black and silver (Ag).

The negative electrode coating layer 33 may further include other additives in addition to the metal and carbon. The negative electrode coating layer 33 may further include, for example, at least one additive such as or including at least one of a binder, a filler, a coating agent, a dispersant, and an ion conductive auxiliary.

The negative electrode coating layer 33 may have a thickness that is less than the thickness of the positive electrode active material layer 23. For example, the negative electrode coating layer 33 may have a thickness that is equal to or less than about 50%, 40%, 30%, 20%, 10%, or 5% of the thickness of the positive electrode active material layer 23. The thickness of the negative electrode coating layer 33 may be, for example, in a range of about 1 μm to about 20 μm, about 2 μm to about 10 μm, or about 3 μm to about 7 μm. When the thickness of the negative electrode coating layer 33 is excessively or substantially thin, lithium dendrites formed between the negative electrode coating layer 33 and the negative electrode current collector 31 may penetrate and collapse the negative electrode coating layer 33, thereby deteriorating the cycle characteristics of the all-solid-state battery cell 10. On the other hand, when the thickness of the negative electrode coating layer 30 is excessively or substantially increased, the energy density of the all-solid-state battery cell 10 may decrease, and the internal resistance of the all-solid-state battery cell 10 may increase due to the negative electrode coating layer 33, thereby deteriorating the cycle characteristics of the all-solid-state battery cell 10.

Although not shown, a carbon layer for improving adhesion between the coating layer 33 and the solid electrolyte layer 40 may be further included.

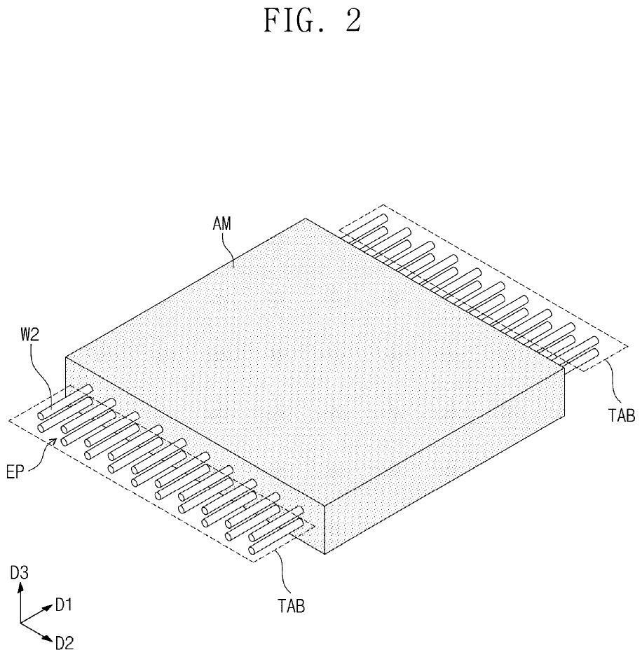

Referring to FIGS. 2 to 10, the rechargeable lithium battery 100 according to example embodiments of the present disclosure may include an electrode substrate EP, an electrode active material block AM, and a membrane MBK.

Here, the electrode for a rechargeable lithium battery may include an electrode substrate EP and an electrode active material block AM. The electrode substrate EP and the electrode active material block AM described below may be descriptions of an electrode for a rechargeable lithium battery according to example embodiments of the present disclosure. The electrode substrate EP, the electrode active material block AM, and the membrane MBK described below may be descriptions of a rechargeable lithium battery according to example embodiments of the present disclosure.

The electrode substrate EP may constitute a current collector on which the electrode active material block AM is coated. The electrode substrate EP may include a positive electrode current collector and a negative electrode current collector.

In example embodiments of the present disclosure, the electrode substrate EP may be configured in the form of a wire W0. Accordingly, the electrode substrate EP may include at least one wire W0. When the electrode substrate EP is applied to a positive electrode layer, the wire W0 may be a positive electrode current collector. When the electrode substrate EP is applied to a negative electrode layer, the wire W0 may be a negative electrode current collector.

The electrode active material block AM may include a positive electrode active material block AM2 and a negative electrode active material block AM1.

When the electrode active material block AM is the negative electrode active material block AM1, the material of the wire W0 may include at least one of copper, nickel, a copper-nickel alloy, stainless steel, titanium, nickel foam, copper foam, a polymer substrate coated with a conductive metal, carbon, or a combination thereof.

When the electrode active material block AM is the positive electrode active material block AM2, the material of the wire W0 may include at least one of aluminum, an aluminum-nickel alloy, or a combination thereof.

In example embodiments of the present disclosure, a three-dimensional structure DSA may be formed in a partial region of the electrode substrate EP.

The electrode substrate EP may include a coated region CA and a non-coated region NCA. The coated region CA may be defined as a region on which the electrode active material block AM is coated. The non-coated region NCA may be defined as a region where the electrode active material is not coated.

The electrode substrate EP may include a first wire part W1 and a second wire part W2. The first wire part W1 may be disposed in the coated region CA. The second wire part W2 may be disposed in the non-coated region NCA.

The three-dimensional structure DSA may be formed on the first wire part W1.

The second wire part W2 may be formed as an electrode tab TAB. Referring to FIG. 2, a pair of second wire parts W2 may be connected to both sides of the electrode active material block AM.

Since the pair of second wire parts W2 form the electrode substrate EP, the pair of second wire parts W2 may constitute a pair of electrode tabs TAB connected to both sides of the electrode active material block AM.

The second wire part W2 connected to one side of the electrode active material block AM may be completely cut according to design specifications. In this case, the second wire part W2 connected to the other side of the electrode active material block AM may be formed as single electrode tab TAB.

The second wire part W2 connected to both sides of the electrode active material block AM may be left depending on design specifications. In this case, a pair of second wire parts W2 connected to both sides of the electrode active material block AM may be formed as a pair of electrode tabs TAB.

The three-dimensional structure DSA according to example embodiments of the present disclosure to be described below may include at least one of a polygonal shape, a circular shape, or a combination thereof.

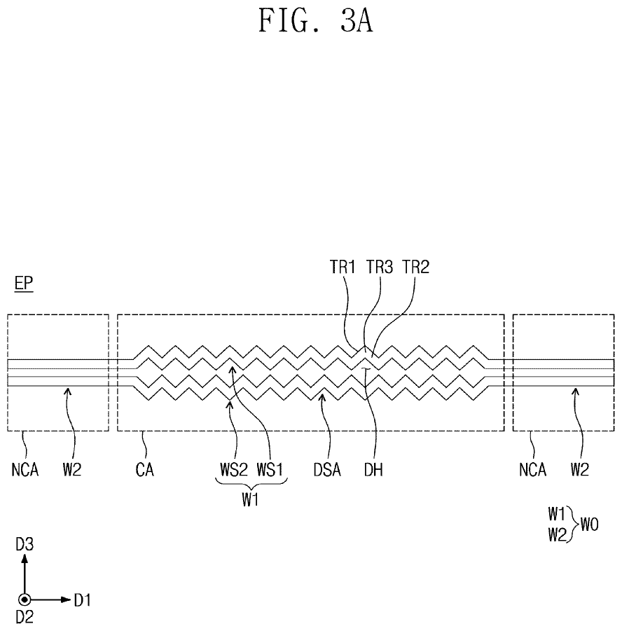

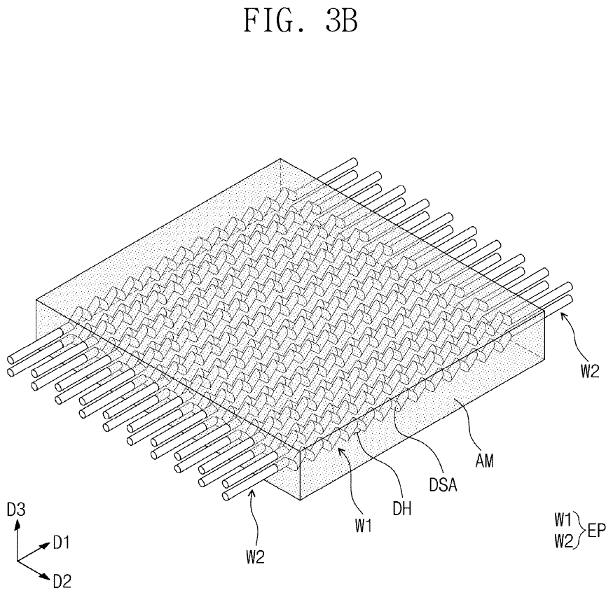

Referring to FIGS. 3A to 5B, the three-dimensional structure DSA may include an opening DH. The electrode active material block may pass through the opening DH and may surround the three-dimensional structure DSA. In other words, the three-dimensional structure DSA may be embedded in the electrode active material block.

FIGS. 3A and 3B illustrate an example embodiment of an electrode substrate EP.

Referring to FIG. 3A, a three-dimensional structure DSA may be formed on the first wire part W1. The second wire part W2 may be formed linearly. In an example embodiment of the electrode substrate EP, the three-dimensional structure DSA may be formed in, e.g., a triangular shape. The three-dimensional structure DSA may be arranged in plurality along the longitudinal direction D1 of the first wire part W1.

The three-dimensional structure DSA may protrude in the third direction D3. For example, a first side TR1 may be inclined in the third direction D3 toward a second side TR2, the second side TR2 may be inclined in a third direction D3 toward the first side TR1, and a corner TR3 where the first side TR2 and the second side TR1 meet may protrude in the third direction D3.

Although not illustrated in the drawings, the three-dimensional structure DSA may protrude in the second direction D2. For example, the first side TR1 may be inclined in the second direction D2 toward the second side TR2, the second side TR2 may be inclined in a second direction D2 toward the first side TR1, and the corner TR3 where the first side TR 1 and the second side TR 2 meet may protrude in the second direction D2.

The first wire part W1 may include a plurality of first wire parts W1. The second wire part W2 may include a plurality of second wire parts W2.

The plurality of first wire parts W1 and the plurality of second wire parts W2 may be arranged in a plurality of layers along the third direction D3.

In such a structure, referring to FIG. 3A, the triangular three-dimensional structure DSA formed on a first upper wire part WS1, which is disposed at the upper side, may protrude in the upward direction. The triangular three-dimensional structure DSA formed on a first lower wire part WS2, which is disposed at the lower side, may protrude in the downward direction.

Referring to FIG. 3B, the plurality of first wire parts W1 and the plurality of second wire parts W2 may be arranged in multiple columns along the second direction D2.

Accordingly, a plurality of three-dimensional structures DSA may be disposed along the first direction D1, and a plurality of three-dimensional structures DSA are disposed along the second direction D2. In general, a plurality of three-dimensional structures DSA may be arranged in multiple rows and columns on a plane defined by the first and second directions D1 and D2.

The electrode active material block AM may be coated on the coated region CA of the electrode substrate EP. In other words, the electrode active material block AM may be coated on the first wire part W1 so that the first wire part W1 is embedded in the electrode active material block AM. The electrode active material block AM may be coated to surround the three-dimensional structure DSA of the first wire part W1. Since the electrode active material block AM is coated on the three-dimensional structure DSA of the first wire part W1, the three-dimensional structure DSA may stably support the shape of the electrode active material block AM.

When the electrode active material block AM is simply coated on the linear wire W0, the linear wire W0 may not be able to stably support the shape of the electrode active material block AM in the third direction D3. In this case, the shape of the electrode active material block AM in the third direction D3 may collapse during the stacking step of the manufacturing process. Alternatively, during the operation of the rechargeable lithium battery, or throughout multiple cycles of expansion and contraction during charging and discharging, the shape of the electrode active material block AM in the third direction D3 may be readily damaged or collapse.

In an example embodiment of the electrode substrate EP, the triangular three-dimensional structure DSA is formed on the wire W0, and the triangular three-dimensional structure DSA is embedded within the electrode active material block AM. As a result, the shape of the electrode active material block AM may be more stably supported.

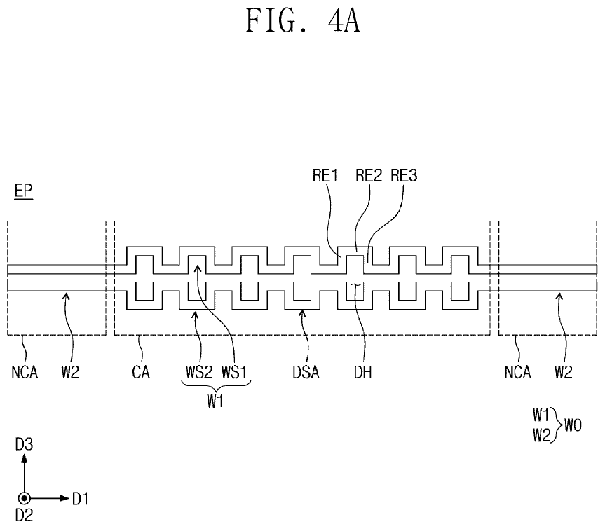

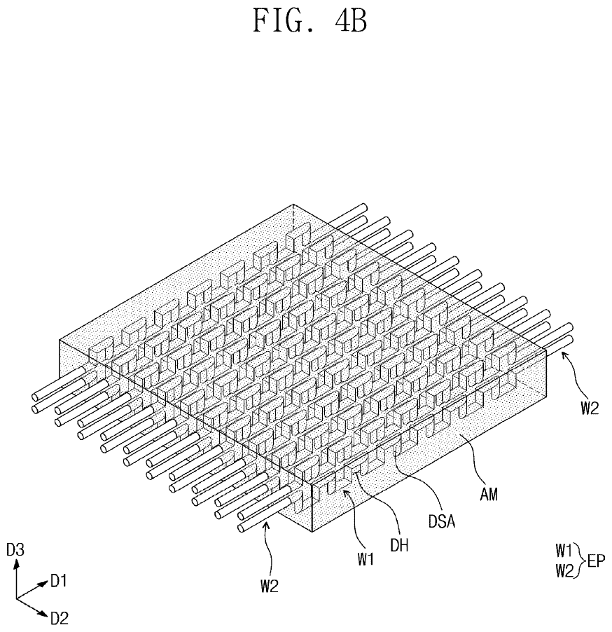

FIGS. 4A and 4B illustrate an example embodiment of the electrode substrate EP.

Referring to FIG. 4A, a three-dimensional structure DSA may be formed on the first wire part W1. The second wire part W2 may be formed linearly. In an example embodiment of the electrode substrate EP, the three-dimensional structure DSA may be formed in, e.g., a rectangular shape. A plurality of three-dimensional structures DSA may be disposed along the longitudinal direction D1 of the first wire part W1.

The three-dimensional structure DSA may protrude in the third direction D3. For example, the first side RE1 may be disposed side by side in the third direction D3 and may face the second side RE2. The third side RE3 may be disposed side by side in the third direction D3 and may face the second side RE2. The second side RE2 may be connected to the first side RE1 and the third side RE3 and may be arranged side by side in the first direction D1.

Although not illustrated in the drawings, the three-dimensional structure DSA may protrude in the second direction D2. For example, the first side RE1 may be disposed side by side in the second direction D2 and may face the second side RE2. The third side RE3 may be disposed side by side in the second direction D2 and may face the second side RE2. The second side RE2 may be connected to the first side RE1 and the third side RE3 and may be arranged side by side in the first direction D1.

The first wire part W1 may include a plurality of first wire parts W1. The second wire part W2 may include a plurality of second wire parts W2.

The plurality of first wire parts W1 and the plurality of second wire parts W2 may be arranged in multiple layers along the third direction D3.

In such structure, referring to FIG. 4A, the rectangular three-dimensional structure DSA formed on a first upper wire part WS1, which is disposed at the upper side, may protrude in the upward direction. The rectangular three-dimensional structure DSA formed on a first lower wire part WS2, which is disposed at the lower side, may protrude in the downward direction.

Referring to FIG. 4B, the plurality of first wire parts W1 and the plurality of second wire parts W2 may be arranged in multiple columns along the second direction D2.

Accordingly, a plurality of three-dimensional structures DSA may be disposed along the first direction D1, and a plurality of three-dimensional structures DSA are disposed along the second direction D2. In general, a plurality of three-dimensional structures DSA may be arranged in multiple rows and columns on a plane defined by the first and second directions D1 and D2.

The electrode active material block AM may be coated on the coated region CA of the electrode substrate EP, as illustrated in FIG. 4A. In other words, the electrode active material block AM may be coated on the first wire part W1 so that the first wire part W1 is embedded in the electrode active material block AM. The electrode active material block AM may be coated to surround the three-dimensional structure DSA of the first wire part W1. Since the electrode active material block AM is coated on the three-dimensional structure DSA of the first wire part W1, the three-dimensional structure DSA may stably support the shape of the electrode active material block AM.

In an example embodiment of the electrode substrate EP, the rectangular three-dimensional structure DSA is formed on the wire W0, and the rectangular three-dimensional structure DSA is embedded within the electrode active material block AM. As a result, the shape of the electrode active material block AM may be more stably supported.

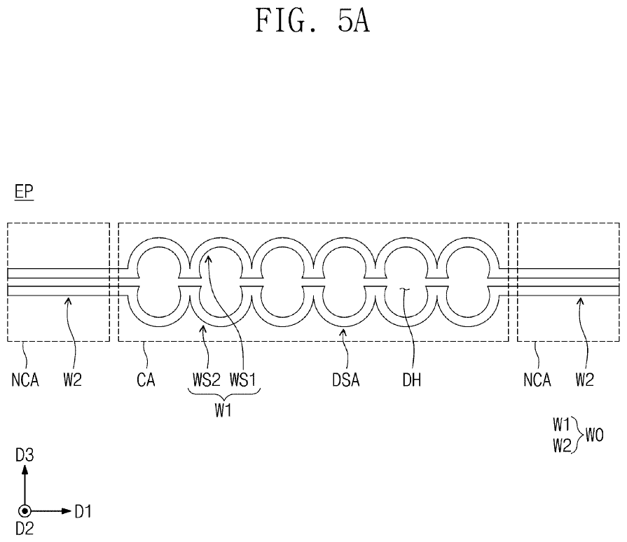

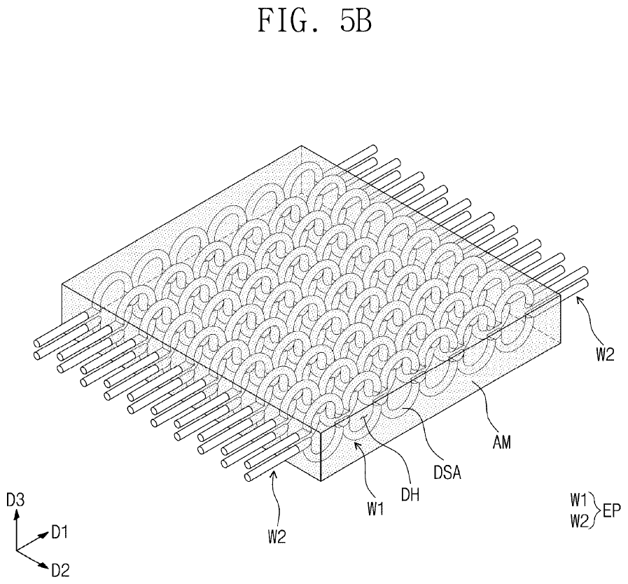

In FIGS. 5A and 5B, an example embodiment of the electrode substrate EP is disclosed. Referring to FIG. 5A, a three-dimensional structure DSA may be formed on the first wire part W1. The second wire part W2 may be formed linearly. In an example embodiment of the electrode substrate EP, the three-dimensional structure DSA may be formed in, e.g., a curved shape. A plurality of three-dimensional structures DSA may be disposed along the longitudinal direction D1 of the first wire part W1.

The three-dimensional structure DSA may protrude in the third direction D3. In other words, the curved three-dimensional structure DSA may form an arch shape along the third direction D3.

Although not illustrated in the drawings, the three-dimensional structure DSA may protrude in the second direction D2. In this case, the curved three-dimensional structure DSA may form an arch shape along the second direction D2.

The first wire part W1 may include a plurality of first wire parts W1. The second wire part W2 may include a plurality of second wire parts W2.

The plurality of first wire parts W1 and the plurality of second wire parts W2 may be arranged in multiple layers along the third direction D3.

In such a structure, referring to FIG. 5A, the curved three-dimensional structure DSA formed on the first upper wire portion WS1, which is disposed at the upper side, may protrude in the upward direction in an arch shape. The curved three-dimensional structure DSA formed on the first lower wire parts WS2, which is disposed at the lower side, may protrude in the downward direction in an arch shape.

Referring to FIG. 5B, the plurality of first wire parts W1 and the plurality of second wire parts W2 may be arranged in multiple columns along the second direction D2.

Accordingly, a plurality of three-dimensional structures DSA may be disposed along the first direction D1. A plurality of three-dimensional structures DSA may be disposed along the second direction D2. A plurality of three-dimensional structures DSA may be arranged in rows and columns on a plane defined by the first and second directions D1 and D2.

The electrode active material block AM may be coated on the coated region CA of the electrode substrate EP. In other words, the electrode active material block AM may be coated on the first wire part W1 so that the first wire part W1 is embedded in the electrode active material block AM. The electrode active material block AM may be coated to surround the three-dimensional structure DSA of the first wire part W1. Since the electrode active material block AM is coated on the three-dimensional structure DSA of the first wire part W1, the three-dimensional structure DSA may stably support the shape of the electrode active material block AM.

In an example embodiment of the electrode substrate EP, the curved three-dimensional structure DSA is formed on the wire W0, and the curved three-dimensional structure DSA is embedded within the electrode active material block AM. As a result, the shape of the electrode active material block AM may be more stably supported.

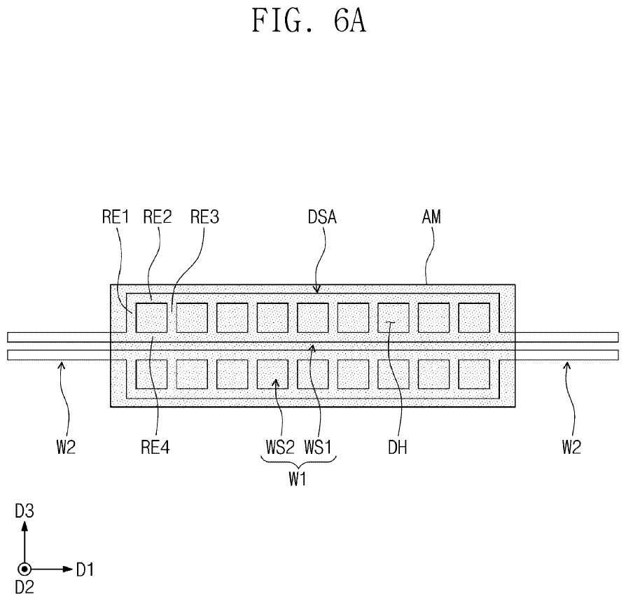

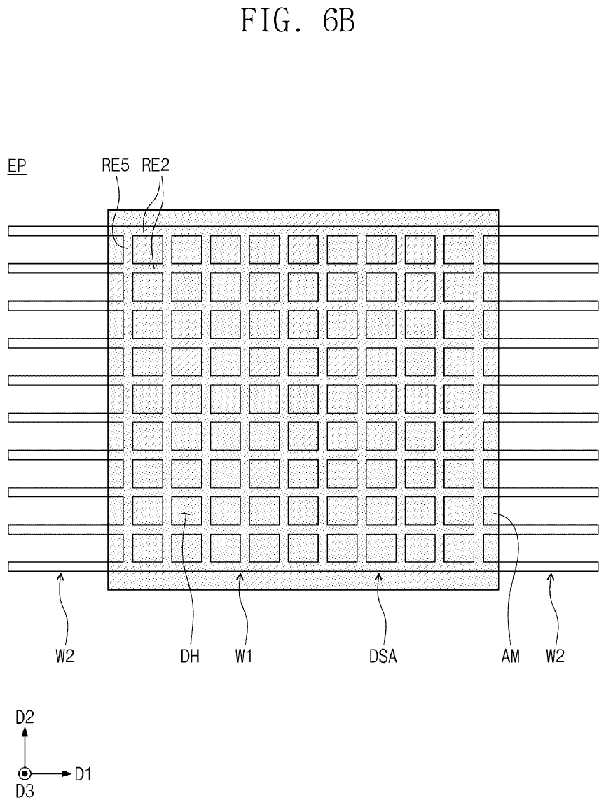

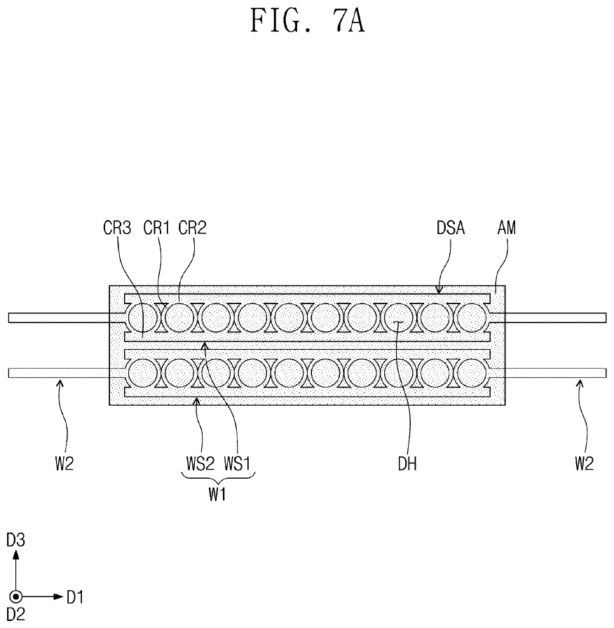

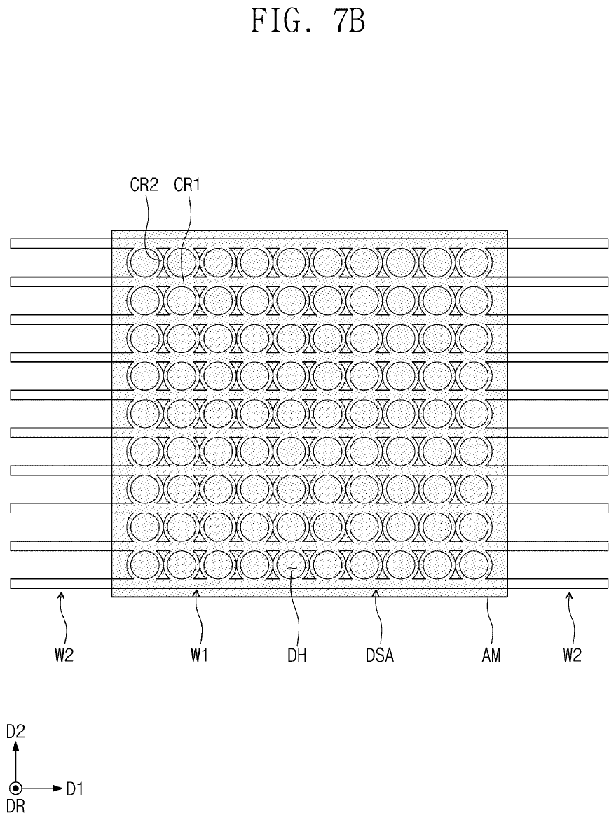

The three-dimensional structure DSA according to example embodiments of the present disclosure described below may include a lattice structure. The three-dimensional structure DSA with the lattice structure may include an opening DH. Referring to FIGS. 6B to 7B, the electrode active material block may pass through the opening DH and may surround the three-dimensional structure DSA having a lattice structure. In other words, the three-dimensional structure DSA with the lattice structure may be embedded in the electrode active material block.

In FIGS. 6A and 6B, an example embodiment of the electrode substrate EP is disclosed. Referring to FIG. 6A, a three-dimensional structure DSA may be formed on the first wire part W1. The second wire part W2 may be formed linearly.

In an example embodiment of the electrode substrate EP, the three-dimensional structure DSA may be formed by a plurality of wires W0 connected in, e.g., a rectangular ring shape. In addition, the rectangular ring shapes may be connected in the first direction D1, the second direction D1, and the third direction D3 to form a hexahedron structure. The hexahedron structures may be interconnected to form a lattice structure.

For example, the three-dimensional structure DSA may protrude in the third direction D3. The first side RE1 may be arranged side by side in the third direction D3 and may be connected to the second side RE2 and the fourth side RE4. The third side RE3 may be arranged side by side in the third direction D3 and may be connected to the second side RE2 and the fourth side RE4. The second side RE2 may be connected to the first side RE1 and the third side RE3 and may be arranged side by side in the first direction D1.

In addition, the fourth side RE4 may be connected to the first side RE1 and the third side RE3 and may be arranged side by side in the first direction D1. The fourth side RE4 may be positioned along the first direction D1 in alignment with the second wire part W2. The second side RE2 may be spaced apart from the fourth side RE4 by a distance equal to the length of the first side RE1 (or the third side RE3) along the third direction D3.

Referring to FIG. 6B, the three-dimensional structure DSA may also be arranged in the second direction D2. For example, the fifth side RE5 may be arranged side by side in the second direction D2 and may connect the second side RE2 adjacent to each other.

Although not illustrated in the drawings, the fifth side RE5 may connect the fourth sides RE4 adjacent to each other. Referring to FIG. 6A, based on the third direction D3, the fourth side RE4 may be located below the second side RE2, and the fifth side RE5 may be arranged in a pair along the third direction D3 with a spacing equal to the length of the first side RE1 (or the third side RE3).

Through the aforementioned connection structure, the three-dimensional structure DSA may form a hexahedral lattice structure in which rectangular rings are interconnected.

The first wire part W1 may include a plurality of first wire parts W1. The second wire part W2 may include a plurality of second wire parts W2.

The plurality of first wire parts W1 and the plurality of second wire parts W2 may be arranged in multiple layers along the third direction D3.

In such a structure, referring to FIG. 6A, the three-dimensional structure DSA with a hexahedral lattice structure formed on the first upper wire part WS1, which is disposed at the upper side, may protrude in the upward direction. The three-dimensional structure DSA with a hexahedral lattice structure formed on the first lower wire part WS2, which is disposed at the lower side, may protrude in the downward direction.

Referring to FIG. 6B, the plurality of first wire parts W1 and the plurality of second wire parts W2 may be arranged in multiple columns along the second direction D2. Accordingly, the three-dimensional structure DSA with a hexahedral lattice structure may form a lattice-shaped plate with a rectangular pattern on a plane defined by the first and second directions D1 and D2.

The electrode active material block AM may be coated on the coated region CA of the electrode substrate EP. In other words, the electrode active material block AM may be coated on the first wire part W1 so that the first wire part W1 may be embedded in the electrode active material block AM. Since the electrode active material block AM is coated on the three-dimensional structure DSA of the first wire part W1, the three-dimensional structure DSA may stably support the shape of the electrode active material block AM.

In an example embodiment of the electrode substrate EP, the three-dimensional structure DSA having a hexahedral lattice structure may be formed on the wire W0, and the three-dimensional structure DSA having the hexahedron lattice structure may be embedded in the electrode active material block AM, so that the shape of the electrode active material block AM may be more stably supported.

In FIGS. 7A and 7B, an example embodiment of the electrode substrate EP is disclosed. Referring to FIG. 7A, a three-dimensional structure DSA may be formed on the first wire part W1. The second wire part W2 may be formed linearly.

In an example embodiment of the electrode substrate EP, the three-dimensional structure DSA may have wires W0 forming a circular ring shape. Additionally, the circular ring shapes may be connected in the first direction D1, the second direction D2, and the third direction D3 to form a hexahedral structure. Furthermore, the hexahedral structures may be interconnected to form a lattice structure.

For example, the three-dimensional structure DSA may protrude in the third direction D3. The three-dimensional structure DSA may include a first ring CR1 disposed along the third direction D3.

The first rings CR1 may be arranged in plurality along the longitudinal direction D1 of the first wire part W1. The plurality of first rings CR1 may be interconnected along the longitudinal direction D1 of the first wire part W1. Each of the first rings CR1 located at the outermost edges may be connected to the first wire part W1.

The three-dimensional structure DSA may also be disposed along the second direction D2. The three-dimensional structure DSA may include a second ring CR2 and a third ring CR3. With reference to the third direction D3, the second ring CR2 may be disposed above (or on one side of) the first ring CR1. The third ring CR3 may be disposed below (or on the opposite side of) the first ring CR1.

The second rings CR2 may be arranged in a plurality along the longitudinal direction D1 of the first wire part W1 above the first ring CR1. The plurality of second rings CR2 may be interconnected along the longitudinal direction D1.

The third rings CR3 may be arranged in a plurality along the longitudinal direction D1 of the first wire part W1 below the first ring CR1. The plurality of third rings CR3 may be interconnected along the longitudinal direction D1.

Through the aforementioned connection structure, the three-dimensional structure DSA may form a hexahedral lattice structure in which circular rings are interconnected.

The first wire part W1 may include a plurality of first wire parts W1. The second wire part W2 may include a plurality of second wire parts W2.

The plurality of first wire parts W1 and the plurality of second wire parts W2 may be arranged in multiple layers along the third direction D3.

In such a structure, referring to FIG. 7A, the three-dimensional structure DSA with a hexahedral lattice structure formed on the first upper wire part WS1 may be embedded in the upper part of the electrode active material block AM to support the shape of the electrode active material block AM. Similarly, the three-dimensional structure DSA with a hexahedral lattice structure formed on the first lower wire part WS2 may be embedded in the lower part of the electrode active material block AM to support the shape of the electrode active material block AM.

Referring to FIG. 7B, the plurality of first wire parts W1 and the plurality of second wire parts W2 may be arranged in multiple columns along the second direction D2.

Accordingly, the three-dimensional structure DSA with the hexahedral lattice structure may form a lattice-shaped plate with a circular pattern on a plane defined by the first and second directions D1 and D2.

The electrode active material block AM may be coated on the coated region CA of the electrode substrate EP. In other words, the electrode active material block AM may be coated on the first wire part W1 so that the first wire part W1 is embedded in the electrode active material blocks AM. Since the electrode active material block AM is coated on the three-dimensional structure DSA of the first wire part W1, the three-dimensional structure DSA may be able to stably support the shape of the electrode active material block AM.

In an example embodiment of the electrode substrate EP, the three-dimensional structure DSA having a hexahedral lattice structure may be formed on the wire W0, and the three-dimensional structure DSA having the hexahedron lattice structure may be embedded in the electrode active material block AM, so that the shape of the electrode active material block AM may be more stably supported.

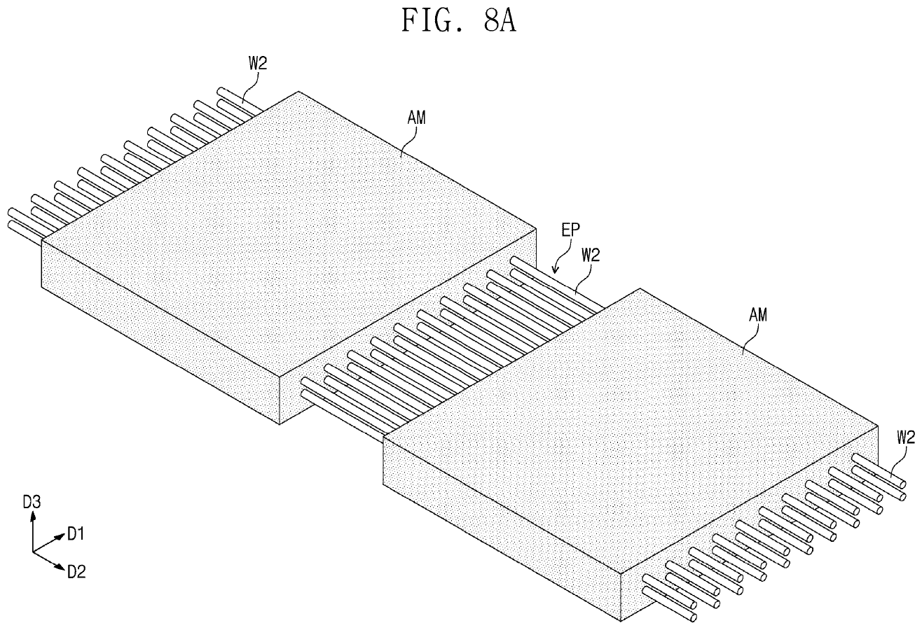

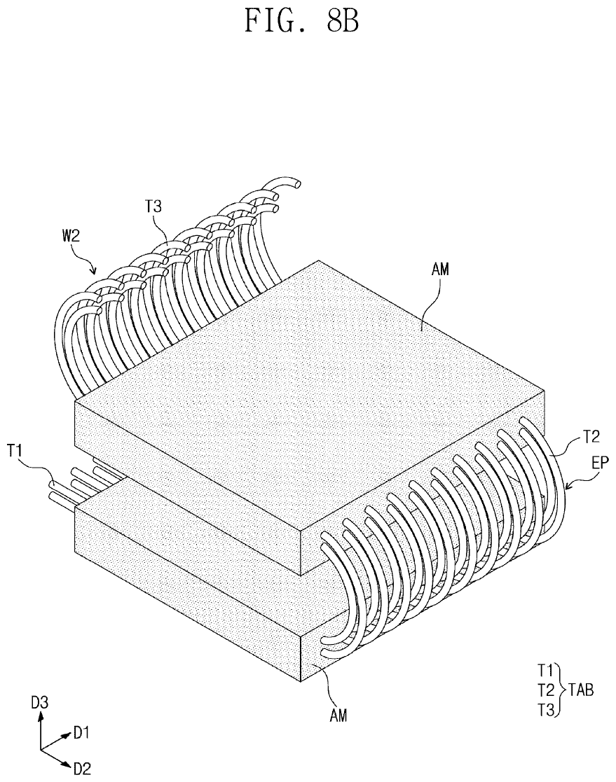

Referring to FIGS. 8A and 8B, an electrode active material block AM according to example embodiments of the present disclosure may include a plurality of electrode active material blocks AM.

The electrode substrate EP may include a plurality of first wire parts W1 and a plurality of second wire parts W2. The plurality of first wire parts W1 and the plurality of second wire parts W2 may be alternately arranged along the longitudinal direction D1 of the electrode substrate EP.

Each of the plurality of first wire parts W1 may be embedded within the respective electrode active material blocks AM.

Referring to FIG. 8A, the electrode active material blocks AM adjacent to each other may be disposed with the second wire part W2 interposed therebetween. Although not illustrated in the drawings, each of the electrode active material blocks AM adjacent to each other may be coated on the first wire parts W1 located on both sides of the second wire part W2.

Referring to FIG. 8B, some of the plurality of second wire parts W2 may be folded in the third direction D3. For example, the second wire part W2 forming the lower electrode tab T1 may be folded in the third direction D3. Accordingly, the plurality of electrode active material blocks AM respectively coated on the plurality of first wire parts W1 may be stacked along the third direction D3.

Although In FIG. 8B illustrates two electrode active material blocks AM stacked along the third direction D3, a greater number of electrode active material blocks AM may be coated onto the first wire parts W1 of the electrode substrate EP. Accordingly, when the second wire parts W2 are folded along the third direction D3, the electrode active material blocks AM may be stacked in multiple layers, forming a greater number of stacked layers.

The second wire part W2 may form an electrode tab TAB.

Referring to FIG. 8A, second wire parts W2 may be disposed on both sides of the electrode active material block AM.

Since the second wire part W2 forms the electrode substrate EP, a pair of second wire parts W2 connected to both sides of the electrode active material block AM may be formed of or include a pair of electrode tabs TAB.

Referring to FIG. 8B, as the plurality of electrode active material blocks AM are stacked along the third direction D3, a plurality of electrode tabs T1 to T3 may be formed.

With reference to the third direction D3, the lower electrode tab T1 and the upper electrode tab T3 may each form an electrode tab by welding together the plurality of wires arranged in the second direction D2. The intermediate electrode tab T2 may form an electrode tab by being cut and then having the plurality of wires arranged in the second direction D2 gathered and welded together. Alternatively, the intermediate electrode tab T2 may form an electrode tab by being compressed from the bent state thereof, as shown in FIG. 8B, into a flattened state, and having the plurality of wires arranged in the second direction D2 gathered and welded together.

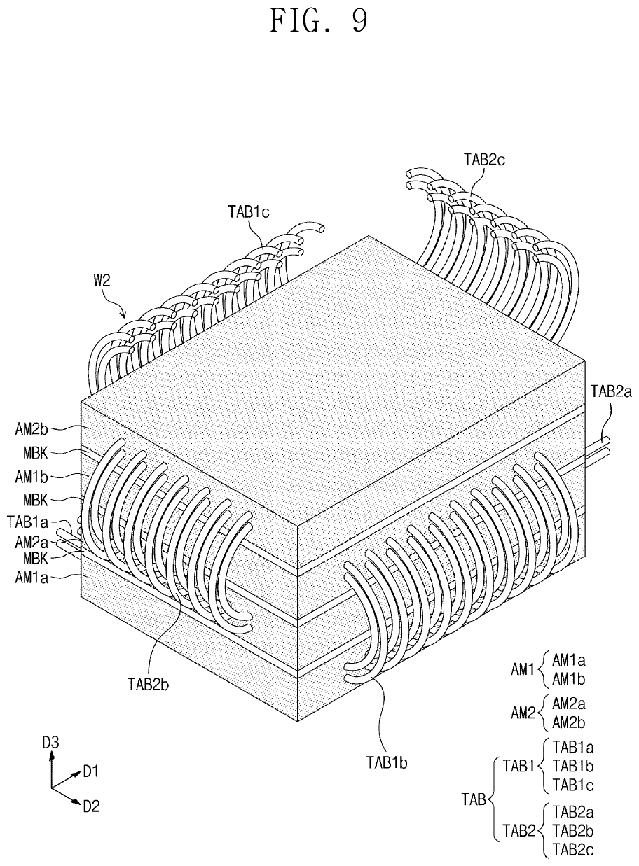

FIG. 9 illustrates a rechargeable lithium battery stacked in a bi-cell form according to example embodiments of the present disclosure.

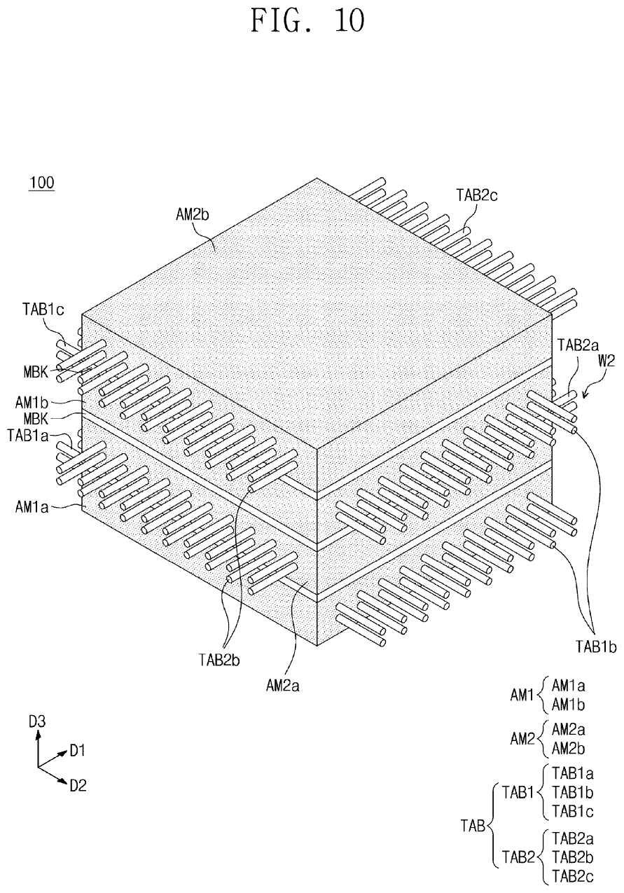

FIG. 10 illustrates a state in which the second wire part W2 of the electrode substrate EP in FIG. 9 is cut to form the second wire part W2 as an electrode tab TAB.

Referring to FIG. 9, the electrode active material block AM may include a plurality of negative electrode active material blocks AM2 and a plurality of positive electrode active material blocks AM1.

The plurality of negative electrode active material blocks AM2 may be coated on the first wire part W1 of the electrode substrate EP. Additionally, by folding the second wire part W2 in the vertical direction, the plurality of negative electrode active material blocks AM1 may be stacked in a third direction D3.

The second wire part W2 connected to the negative electrode active material block AM1 may form a negative electrode tab TAB1. As illustrated in FIG. 9, a plurality of negative electrode tabs TAB1a, TAB1b, and TAB1c may be formed by stacking the plurality of negative electrode active material blocks AM2 in the third direction D3.

Also, in the same manner, a plurality of positive electrode active material blocks AM1 may be coated on the first wire part W1 of the electrode substrate EP. Then, the plurality of positive electrode active material blocks AM2 may be stacked in the third direction D3 by folding the second wire part W2 in the vertical direction.

The second wire part W2 connected to the positive electrode active material block AM2 may form a positive electrode tab TAB2. As illustrated in FIG. 9, a plurality of positive electrode tabs TAB2a and TAB2b may be formed by stacking the plurality of positive electrode active material blocks AM1 in the third direction D3.

A plurality of positive electrode active material blocks AM1 may be stacked on the plurality of negative electrode active material blocks AM2.

In this case, in order to reduce or prevent the plurality of negative electrode tabs TAB1 and the plurality of positive electrode tabs TAB2 from coming into contact with each other, the plurality of positive electrode material blocks AM1 and the plurality of negative electrode active material blocks AM2 may be stacked with a desired or predetermined crossing angle.

In an example embodiment of the present disclosure, the crossing angle may be approximately 90°. However, the crossing angle is not limited thereto and may include other angle ranges as long as the plurality of negative electrode tabs TAB1 and the plurality of positive electrode tabs TAB2 do not come into contact with each other. For example, the crossing angle may be approximately in the range of about 60° to about 120°.

A membrane MBK may be stacked between the positive active material block AM2 and the negative active material block AM1. In an example embodiment of the present disclosure the membrane MBK may be or include a solid electrolyte. In this case, the rechargeable lithium battery 100 of the present disclosure may be an all-solid-state battery. In an example embodiment of the present disclosure, the membrane MBK may be or include a separator. In this case, the rechargeable lithium battery 100 of the present disclosure may be a lithium-ion battery.

Through the stacked structure, the rechargeable lithium battery 100 according to an example embodiment of the present disclosure may be configured in a bi-cell form. In the example embodiment of the present disclosure, the bi-cell may be defined as a battery cell in which a negative electrode active material block AM1 (or a negative electrode layer), a membrane MBK, a positive electrode active material block AM2 (or a positive electrode layer), the membrane MBK, and the negative electrode active material block AM1 (or negative electrode layer) are stacked, e.g., sequentially stacked, to form a plurality of layers.

Referring to FIG. 10, a plurality of electrode tabs TAB1a to TAB1c and TAB2a to TAB2c separated from each other may be formed by cutting a plurality of second wire parts W2.

A pair of negative electrode tabs TAB1 may be disposed on both sides of the negative electrode active material block AM1 along the first direction D1.

The negative electrode material block AM1 disposed at the lower side among the negative electrode active material blocks AM1 respectively disposed at the upper and lower sides may be connected to a first negative electrode tab TAB1a and a second negative electrode tab TAB1b.

Referring to FIG. 9, the second negative electrode tab TAB1b is bent, and when the second negative tab TAB1b is cut, the first negative electrode tab TAB1a and the second negative electrode tab TAB1b may be disposed on both sides of the negative electrode active material block AM1 positioned at the lower side.

The negative electrode material block AM1 disposed at the upper side among the negative electrode active material blocks AM1 respectively disposed at the upper and lower sides may be connected to a second negative electrode tab TAB1b and a third negative electrode tab TAB1c.

Referring to FIG. 9, the second negative electrode tab TAB1b is bent, and when the second negative electrode tab TAB1b is cut, the second negative electrode tab TAB1b and the third negative electrode tab TAB1c may be disposed on both sides of the negative electrode active material block AM1 positioned at the upper side.

When one of the pair of negative electrode tabs TAB1 disposed on both sides of the negative electrode active material block AM1 is completely cut using, e.g., an electrode tab cutting device, the negative electrode tab TAB1 may be disposed only on one side of the negative electrode active material block AM1. For example, the first negative electrode tab TAB1a may be removed from among the first and second negative electrode tabs TAB1a and TAB1b connected to the negative electrode active material block AM1 disposed at the lower portion. In this case, only the second negative electrode tab TAB1b may be connected to one side of the negative electrode active material block AM1 disposed at the lower portion.

A pair of positive electrode tabs TAB2 may be formed on both sides of the positive electrode active material block AM2 along the second direction D2.

The positive electrode material block AM2 disposed at the lower side among the positive electrode active material blocks AM2 respectively disposed at the upper and lower sides may be connected to a first positive electrode tab TAB2a and a second positive electrode tab TAB2b.

Referring to FIG. 9, the second positive electrode tab TAB2b is bent, and when the second positive tab TAB2b is cut, the first positive electrode tab TAB2a and the second positive electrode tab TAB2b may be disposed on both sides of the positive electrode active material block AM2 positioned at the lower side.

The positive electrode material block AM2 disposed at the upper side among the positive electrode active material blocks AM2 respectively disposed at the upper and lower sides may be connected to a second positive electrode tab TAB2b and a third positive electrode tab TAB2c.

Referring to FIG. 9, the second positive electrode tab TAB2b is bent, and when the second positive electrode tab TAB2b is cut, the second positive electrode tab TAB2b and the third positive electrode tab TAB2c may be disposed on both sides of the positive electrode active material block AM2 positioned at the upper side.

When one of the pair of positive electrode tabs TAB2 disposed on both sides of the positive electrode active material block AM2 is completely cut using an electrode tab cutting device, the positive electrode tab TAB2 may be disposed only on one side of the positive electrode active material block AM2. For example, the first positive electrode tab TAB2a may be removed from among the first and second positive electrode tabs TAB2a and TAB2b connected to the positive electrode active material block AM2 disposed at the lower portion. In this case, only the second positive electrode tab TAB2b may be connected to one side of the positive electrode active material block AM2 disposed at the lower portion.

According to an example embodiment of the present disclosure, a rechargeable lithium battery may form a three-dimensional structure DSA on the wire-shaped electrode substrate EP through the aforementioned configuration, thereby allowing the electrode active material block AM to be stably coated on the wire-shaped electrode substrate EP. This can enhance the bonding strength between the electrode substrate EP and the electrode active material block AM.

In addition, efficiency in the manufacturing process may be improved by coating a plurality of electrode active material blocks AM on the wire W0 and folding the wire W0 to stack the plurality of electrode active materials blocks AM in a plurality of layers.

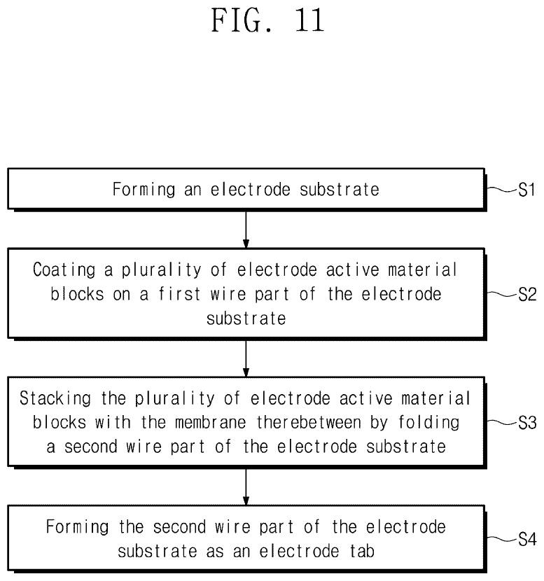

A method for manufacturing a rechargeable lithium battery according to an example embodiment of the present disclosure is described below. FIG. 11 illustrates a method for manufacturing a rechargeable lithium battery according to an example embodiment of the present disclosure.

Referring to FIG. 11, a method for manufacturing a rechargeable lithium battery according to an example embodiment of the present disclosure may include forming an electrode substrate S1, coating the electrode active material block on the electrode substrate S2, stacking the plurality of electrode active material blocks with a membrane therebetween S3, and forming an electrode tab S4.

Forming the electrode substrate S1 may be or include forming the electrode substrate in the form of a wire W0. The electrode substrate EP may include at least one wire W0. For example, the wire W0 may be disposed along the first direction D1. The wire W0 may include a plurality of wires W0. The plurality of wires W0 may be spaced apart from each other along the second direction D2. The plurality of wires W0 may be spaced apart from each other along the third direction D3, and may form a plurality of layers.

When the electrode substrate EP forms a negative electrode layer, the electrode active material block AM may be the negative electrode active material block AM1. The material of the electrode substrate EP may include at least one of copper, nickel, a copper-nickel alloy, stainless steel, titanium, nickel foam, copper foam, a polymer base material coated with a conductive metal, and carbon, or a combination thereof.

When the electrode substrate EP forms a positive electrode layer, the electrode active material block AM may be the positive electrode active material block AM2. The material of the electrode substrate EP may include at least one of aluminum and an aluminum-nickel alloy, or a combination thereof.

With reference to FIGS. 3A-10, forming the electrode substrate S1 may include forming a three-dimensional structure DSA in a partial region of the electrode substrate EP. The electrode substrate EP may include a first wire part W1 and a second wire part W2.

The electrode substrate EP may include a coated region CA and a non-coated region NCA. The first wire part W1 may be disposed in the coated region CA. The second wire part W2 may be disposed in the non-coated region NCA. Accordingly, the partial region where three-dimensional structure DSA is formed may be the coated region CA or the first wire part W1.

Forming the electrode substrate S4 may include forming a three-dimensional structure DSA on a first wire part W1. And a second wire part W2 may be maintained in a linear shape.

In addition, the three-dimensional structure DSA may be formed in various forms. For example, as illustrated in FIGS. 3A and 3B, the three-dimensional structure DSA may be formed in a triangular shape. As illustrated in FIGS. 4A and 4B, the three-dimensional structure DSA may be formed in a rectangular shape. As illustrated in FIGS. 5A and 5B, the three-dimensional structure DSA may be formed in a curved shape. As shown in FIGS. 6A and 6B, the three-dimensional structure DSA may be formed as a rectangular lattice structure. As shown in FIGS. 7A and 7B, the three-dimensional structure DSA may be formed as a circular lattice structure.

In addition, in the step S4 of forming the electrode substrate EP, the three-dimensional structure DSA may be formed in various shapes that are capable of stably supporting the electrode active material block AM.

Coating the electrode active material block on the electrode substrate S2 may include coating the plurality of electrode active material blocks on the plurality of first wire parts W1.

Referring to FIG. 8A, the electrode substrate EP may include a plurality of first wire parts W1 and a plurality of second wire parts W2 formed along the longitudinal direction D1. The plurality of first wire parts W1 and the plurality of second wire parts W2 may be, e.g., alternately disposed.

A plurality of electrode active material blocks AM may be coated on the plurality of first wire parts W1, respectively. Accordingly, a plurality of electrode active material blocks AM may be disposed at desired or predetermined intervals along the longitudinal direction D1 of the electrode substrate EP.

The three-dimensional structure DSA of the first wire part W1 may be embedded in the electrode active material block AM. The three-dimensional structures DSA of the first wire part W1 function as a support frame of the electrode active material block AM, and may support the shape of the electrode active material block AM.

Referring to FIGS. 8B, 9, and 10, stacking the plurality of electrode active material blocks AM with a membrane MBK therebetween S3 may include folding the plurality of electrode active material blocks AM and stacking the plurality of electrode active material blocks AM with membrane MBK interposed therebetween. That is, the plurality of electrode active material blocks AM may be respectively located above and below the membrane MBK with respect to the third direction D3.

The electrode active material block AM may include a plurality of positive electrode active material blocks AM2 and a plurality of negative electrode active material blocks AM1.

The first negative electrode active material block AM1a among the plurality of negative electrode active material blocks AM1 may be disposed, and the membrane MBK may be stacked on the first negative electrode active material block AM1a.

The first positive electrode active material block AM2a among the plurality of positive electrode active material blocks AM2 may be stacked on the membrane MBK.

Membrane MBK may be stacked on the first positive electrode active material block AM2a.

The second wire W0 connected to the first negative electrode active material block AM1a may be folded to stack the second negative electrode active material block AM1b on the membrane MBK.

Membrane MBK may be stacked on the second negative electrode active material block AM1b.

The second wire W0 connected to the first positive electrode active material block AM2a may be folded to stack the second positive electrode active material block AM2b on the membrane MBK.

The above-described stacking process may be repeated a number of times, or may be, e.g., continuously repeated.

Through the above steps, the negative electrode active material block AM1, the membrane MBK, the positive electrode active material block AM2, the membrane MBK, the negative electrode active material blocks AM1, the membrane MBK, and the positive electrode active material block AM2 may be stacked, e.g., sequentially and continuously stacked, to form a bi-cell of the rechargeable lithium battery 100.

In this case, the plurality of positive electrode active material blocks AM2 and the plurality of negative electrode active material blocks AM1 may be stacked on each other at a desired or predetermined crossing angle. This is to hinder or prevent the negative electrode tab TAB1 and the positive electrode tab TAB2 from contacting each other.

In an example embodiment of the present disclosure, the crossing angle may be around 90°. However, the present disclosure is not limited thereto, and may include other angular ranges in which the positive electrode tab TAB1 and the negative electrode tab TAB2 do not contact each other. For example, the crossing angle may be in the range of about 60° to about 120°.

Forming the electrode tab S4 may include forming the second wire W0 of the electrode substrate EP as the electrode tab TAB. The plurality of second wires W0 may be gathered and welded to form the electrode tab TAB. Alternatively, the electrode tab TAB may be formed by welding a separate electrode plate to the plurality of second wires W0.

The second wires W0 connected to the negative electrode active material block AM1 may be gathered and welded to form the negative electrode tab TAB1. Referring to FIG. 10, a plurality of negative electrode tabs TAB1a, TAB1b, and TAB1c may be connected to the negative electrode active material block AM1.

The second wires W0 connected to the positive electrode active material block AM2 may be gathered and welded to form the positive electrode tab TAB2. Referring to FIG. 10, a plurality of positive electrode tabs TAB2a and TAB2b may be connected on the positive electrode active material block AM1.

In this case, the plurality of negative electrode tabs TAB1 and the plurality of positive electrode tabs TAB2 may form a desired or predetermined crossing angle.

In an example embodiment of the present disclosure, the crossing angle intersection may be around 90°. However, the present disclosure is not limited thereto, and may include other crossing angle ranges in which the plurality of negative electrode tabs TAB1 and the plurality of positive electrode tabs TAB2 do not contact each other. For example, the crossing angle may be in the range of about 60° to about 120°.

Through the above manufacturing method, a rechargeable lithium battery 100 in which the binding force between the electrode substrate EP and the electrode active material block AM is increased can be manufactured. The efficiency of the manufacturing process may be improved by coating a plurality of electrode active materials on the wire W0, and folding the wire W0 to stack the plurality of electrode active material blocks AM in a plurality of layers.

The electrode for a rechargeable lithium battery, the rechargeable lithium battery, and the method for manufacturing a rechargeable lithium battery according to examples of the present disclosure may form a three-dimensional structure on a wire-shaped electrode substrate so that an electrode active material is stably coated on the wire-shaped electrode substrate. This may increase the binding force between the electrode substrate and the electrode active material.

In addition, by coating a plurality of electrode active material blocks on a wire and folding the wire to stack the plurality of electrode active material blocks in a plurality of layers, the efficiency in the manufacturing process may be improved.

In addition, by utilizing wires as electrode tabs, electrode tab notching and welding processes can be omitted or the corresponding process steps can be reduced. In this way, it is possible to reduce the waste, damage, and the like of the electrode generated during the process, and even when the width of the electrode is changed, it is also possible to reduce the consumption, loss, and the like, of the auxiliary material by adding and removing the wire. This can improve the process efficiency and lower the production cost.

Ultimately, the productivity of the rechargeable lithium battery manufacturing process can be improved and the manufacturing cost can be reduced.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. An electrode for a rechargeable lithium battery, the electrode comprising:
an electrode substrate; and
an electrode active material block coated on the electrode substrate,
wherein the electrode substrate comprises at least one wire embedded in the electrode active material block,
wherein a partial region of the electrode substrate comprises a three-dimensional structure, and
wherein the electrode active material block surrounds the three-dimensional structure.

2. The electrode as claimed in claim 1, wherein the electrode substrate comprises:
a first wire part embedded in the electrode active material block; and
a second wire part disposed in a non-coated region where the electrode active material block is not coated,
wherein the three-dimensional structure is formed in the first wire part.

3. The electrode as claimed in claim 2, wherein the second wire part forms an electrode tab.

4. The electrode as claimed in claim 2, wherein the electrode active material block is a negative electrode active material block, and
wherein the wire comprises at least one of copper, nickel, a copper-nickel alloy, stainless steel, titanium, nickel foam, copper foam, a polymer substrate coated with a conductive metal, carbon, and a combination thereof.

5. The electrode as claimed in claim 2, wherein the electrode active material block is a positive electrode active material block, and
wherein the wire comprises at least one of aluminum, an aluminum-nickel alloy, and a combination thereof.

6. The electrode as claimed in claim 2, wherein the three-dimensional structure comprises a lattice structure.

7. A rechargeable lithium battery, comprising:
an electrode substrate;
an electrode active material block coated on the electrode substrate; and
a membrane stacked on the electrode active material block,
wherein the electrode substrate comprises at least one wire embedded in the electrode active material block,
wherein a partial region of the electrode substrate comprises a three-dimensional structure, and
wherein the electrode active material block surrounds the three-dimensional structure.

8. The rechargeable lithium battery as claimed in claim 7, wherein the electrode substrate comprises:
a first wire part embedded in the electrode active material block; and
a second wire part disposed in a non-coated region where the electrode active material block is not coated,
wherein the three-dimensional structure is formed in the first wire part.

9. The rechargeable lithium battery as claimed in claim 8,
wherein the electrode active material block comprises a plurality of electrode active material blocks,
wherein the electrode substrate comprises a plurality of first wire parts and a plurality of second wire parts,
wherein the plurality of first wire parts and the plurality of second wire parts are alternately disposed along a longitudinal direction of the electrode substrate, and
wherein the plurality of first wire parts are embedded in the plurality of electrode active material blocks, respectively.

10. The rechargeable lithium battery as claimed in claim 9,
wherein some of the plurality of second wire parts are folded in a third direction, and
wherein the plurality of electrode active material blocks, which are respectively coated on the plurality of first wire parts, are stacked along the third direction.

11. The rechargeable lithium battery as claimed in claim 10,
wherein the plurality of electrode active material blocks comprise a positive electrode active material block and a negative electrode active material block, and
wherein the positive electrode active material block and the negative electrode active material block are stacked with the membrane interposed therebetween.

12. The rechargeable lithium battery as claimed in claim 11, wherein the second wire part connected to the positive electrode active material block and the second wire part connected to the negative electrode active material block are stacked in such a way that a desired crossing angle is formed, ensuring that the second wire part connected to the positive electrode active material block and the second wire part connected to the negative electrode active material block do not contact each other.

13. A method for manufacturing a rechargeable lithium battery, the method comprising:
forming an electrode substrate, the electrode substrate comprising at least one wire; and
coating an electrode active material block on the electrode substrate,
wherein the at least one wire is embedded in the electrode active material block, and
wherein forming the electrode substrate comprises forming a three-dimensional structure in a partial region of the electrode substrate.

14. The method as claimed in claim 13,
wherein the electrode substrate comprises a first wire part embedded in the electrode active material block and a second wire part disposed in a non-coated region where the electrode active material block is not coated, and
forming the electrode substrate comprises forming a three-dimensional structure in the first wire part.

15. The method as claimed in claim 14,
wherein the electrode active material block comprises a plurality of electrode active material blocks,
wherein the electrode substrate comprises a plurality of first wire parts and a plurality of second wire parts,
wherein the plurality of first wire parts and the plurality of second wire parts are alternately disposed along a longitudinal direction, and
wherein coating the electrode active material block comprises coating the plurality of electrode active material blocks on the plurality of first wire parts, respectively.

16. The method as claimed in claim 15, further comprising:
stacking the plurality of electrode active material blocks with a membrane interposed therebetween.

17. The method as claimed in claim 16, wherein stacking the plurality of electrode active material blocks comprises:
folding some of the plurality of second wire parts in a third direction; and
disposing each pair of the plurality of electrode active material blocks such that one pair is positioned on an upper side and the other pair on a lower side of the membrane along the third direction.

18. The method as claimed in claim 17,
wherein the plurality of electrode active material blocks comprise a positive electrode active material block and a negative electrode active material block, and
wherein the positive electrode active material block and the negative electrode active material block are stacked with the membrane interposed therebetween.

19. The method as claimed in claim 18, wherein stacking the plurality of electrode active material blocks with the membrane interposed therebetween comprises:
stacking the second wire part connected to the positive electrode active material block and the second wire part connected to the negative electrode active material block in such a way that a desired crossing angle is formed, ensuring that they do not contact each other.

20. The method as claimed in claim 14, further comprising forming an electrode tab,
wherein forming the electrode tab comprises forming the second wire part as the electrode tab.
